(19) United States
(12) Patent Application Publication
(10) Pub. No.: US 2012/0084986 A1
(43) Pub. Date: Apr. 12, 2012

(54) Dust collecting vacuum hose attachment

(76) Inventor: Gary A. Klawitter, Vineland, NJ (US)

(21) Appl. No.: 12/924,840

(22) Filed: Oct. 7, 2010

(51) Int. Cl. B27B 21/00

(52) U.S. Cl. 30/516

(57) ABSTRACT

A dust collecting vacuum hose attachment has a unitary, hollow, tubular body member. One end of an elongated cutting blade is secured within the body member and the second end extends out of the body member. A dust collection shroud is removeably attached to the upper end of the body member for the collection of dust created by use of the saw blade through a dust creating material such as wood, drywall, etc. The lower end of the body member utilizes a connection fitting for attachment to a vacuum hose, which in turn is connected to a vacuum source. Dust created during sawing is collected and accumulated within the shroud by the suction provided by the vacuum source. The dust in turn is sucked through the body member, into a vacuum hose, and then to the vacuum source. The shroud is removeable from the body member in favor of a rasp component which collects and accumulates created dust which is also discharged by means of a vacuum source.

### BACKGROUND OF THE INVENTION

There are quite a number of electrically powered saws, sanders, and other saw and similar dust creating tools which utilize a variety of means to collect, accumulate and discharge dust from the area of the work. Many of these tools are elaborate, heavy, and expensive. Others are difficult to operate or otherwise not practical in actual use. While some dust removal tools are effective, it is often cumbersome or impractical to use them for smaller jobs or jobs which are better served by manually manipulating hand saws, sanders, rasps, or other tools in which dust is a by-product. Unfortunately, there is no simple and effective means to collect the dust created by the use of such hand tools. As a result, dust which is created is dispersed from the area where the work is being done, onto surrounding external surfaces and on the worker himself.

### SUMMARY OF THE INVENTION

It is therefore the object of the present invention to provide a dust collecting vacuum hose attachment which addresses the problems associated with the use of saws, sanders, rasps, and other hand tools which create dust in the work environment.

It is an object of the present invention to provide a dust collecting vacuum hose attachment which captures dust created by a saw blade, a rasp element, or other dust creating tool, contemporaneously with the use of the attachment on the work material which creates dust.

It is another object of the present invention to provide a dust collecting vacuum hose attachment which has the versatility to be used with a saw blade, a rasp element, or other dust creating tool.

It is still another object of the present invention to provide a dust collecting vacuum hose attachment which is versatile, in that saw blades, rasp elements, or other dust creating tools can be interchangeably utilized.

It is a further object of the present invention to provide a dust collecting vacuum hose attachment which can readily be used with an existing vacuum cleaner or equivalent vacuum source.

These and other objects are accomplished by the present invention, a dust collecting vacuum hose attachment which comprises a unitary, hollow, tubular body member. One end of an elongated cutting blade is secured within the body member and the second end extends out of the body member. A dust collection shroud is removeably attached to the upper end of the body member for the collection of dust created by use of the saw blade through a dust creating material such as wood, drywall, etc. The lower end of the body member utilizes a connection fitting for attachment to a vacuum hose, which in turn is connected to a vacuum source. Dust created during sawing is collected and accumulated within the shroud by the suction provided by the vacuum source. The dust in turn is sucked through the body member, into a vacuum hose, and then to the vacuum source. The shroud is removeable from the body member in favor of a rasp component which collects and accumulates created dust which is also discharged by means of a vacuum source.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the use of the dust collecting vacuum hose attachment of the present invention in conjunction with a vacuum source.

FIG. 2 is an elevation view of the dust collecting vacuum hose attachment of the present invention with its shroud attached.

FIG. 3 is an elevation view of the dust collecting vacuum hose attachment of the present invention with its shroud removed.

FIG. 4 is a cross-sectional view of the dust collecting vacuum hose attachment of the present invention shown in FIG. 2.

FIG. 5 shows the manner of use of the dust collecting vacuum hose attachment of the present invention.

FIG. 6 shows the rasp component of the dust collecting vacuum hose attachment of the present invention.

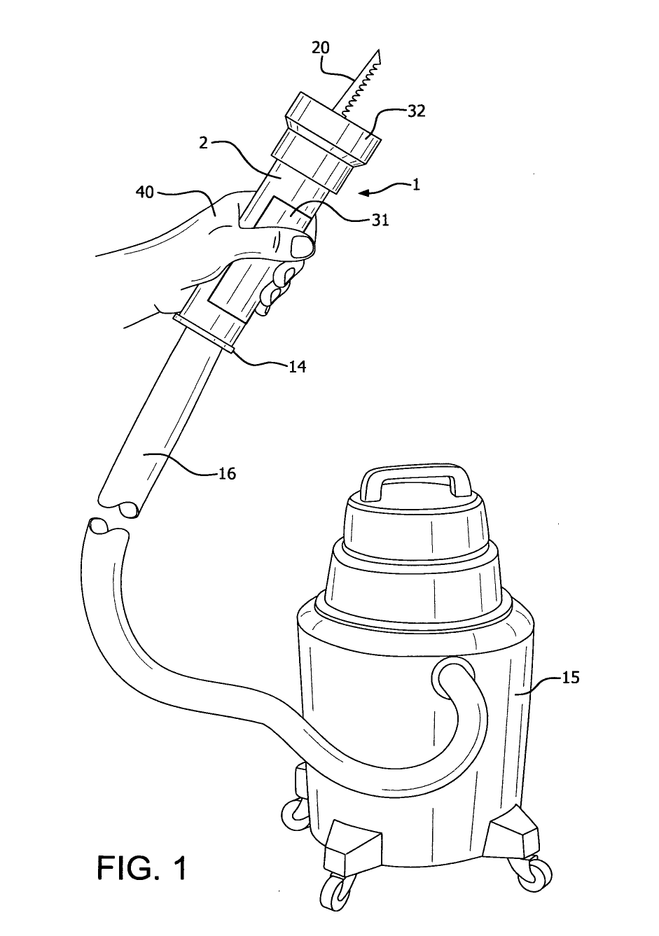

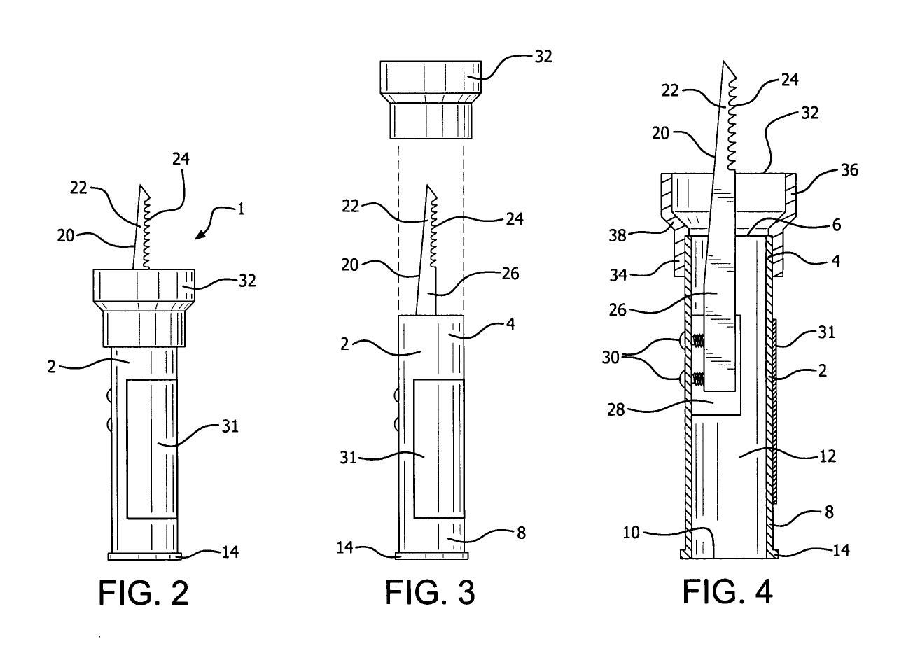

### DETAILED DESCRIPTION OF THE INVENTION

Vacuum hose attachment 1 of the present invention comprises unitary, hollow, tubular body member 2 having upper end 4 with opening 6, lower end 8 with opening 10, and internal through passage 12. Lower end 8 comprises vacuum hose connection fitting 14 configured to be attached to vacuum source 15 via vacuum hose 16.

Elongated saw blade 20 comprises upper section 22 on which cutting teeth 24 are located. Lower section 26 of blade 20 is inserted into and secured to connector element 28, itself located with passage 12 and secured to an internal wall of body member 2, such that the saw blade's lower section is housed within the body member and its upper section 22 extends out of the body member. Lower section 26 of blade 20 is permanently inserted, secured and anchored into connector element 28 by threaded engagement, adhesive, or equivalent attachment means. Connector element 28 is attached to body member 2 by screws, rivets, or like connectors 30. Hand grip surface 31 surrounds body member 2 to facilitate handling of attachment 1.

Shroud 32 comprises a truncated, hollow, cylindrical member which is shorter in length than body member 2 and which is also open at each end. Shroud 32 has rearward section 34, forward section 36, and angled intermediate section 38. Rearward section 34 has an internal diameter which is slightly greater than the external diameter of upper end 4 of body member 2, such that the shroud can be removeably, yet snugly, fit over the upper end of the body member. Angled section 38 tapers outward from rearward section 34 to forward section 36, which has an inside diameter substantially greater than the inside diameter of the rearward section.

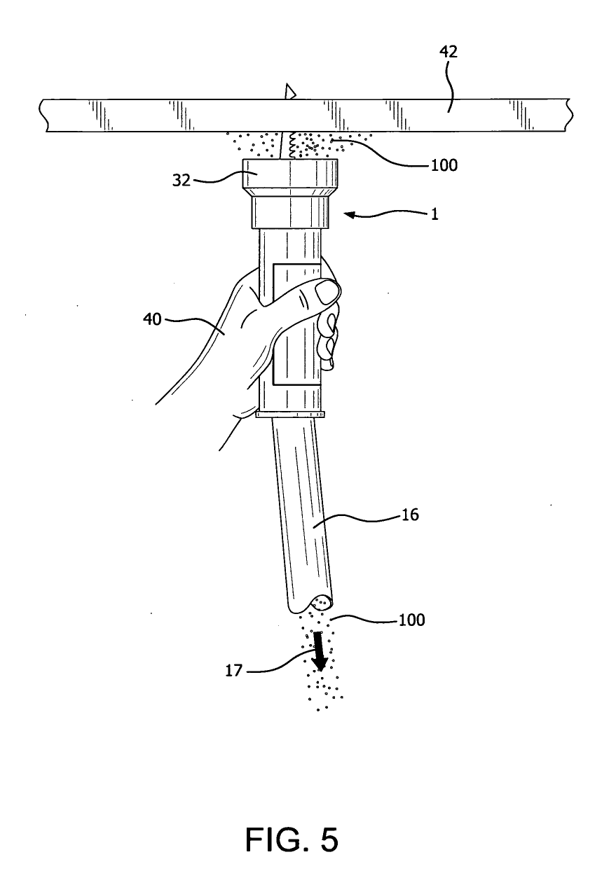

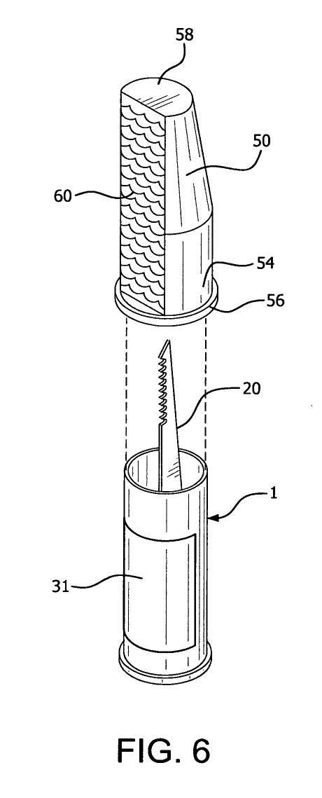

In use, vacuum hose 16, connected to vacuum source 15, e.g. a vacuum cleaner, is secured within hose connection fitting 14 of body member 2 attachment 1 and the vacuum source is turned on. The user, with his or her hand 40 encircled around grip surface 31 of body member 2, now utilizes saw blade 20 of tool attachment 1 to cut drywall, wood, or like material 42. As best seen in FIG. 5, dust 100, created by the sawing action of tool attachment 1, will be captured, collected, and accumulated within shroud 32. The ongoing suction force 17 provided by vacuum source 15 will suck the dust 100 from shroud 32 and through passage 12 of body member 2, discharging it through the passage, into vacuum hose 16, and then to the vacuum source, e.g. a vacuum cleaner (not shown in FIG. 5).

Use of hose attachment 1 will thus efficiently and effectively capture, collect, and remove dust created by manual sawing of drywall and the like. Use of attachment 1 is particularly effective in making cuts in overhead ceilings, where gravity causes sawdust to otherwise fall freely on the user. Attachment 1 catches this dust from the site of the work and suctions it away for discharge elsewhere.

Hose attachment 1 can also be adapted for use in dust creating filing activity. Rasp component 50 comprises a hollow, partially cylindrically shaped member. It has a rearward section which is opened, and attachment fitting 56. Like rearward section 34 of shroud 32, rearward section 54 has an internal diameter which is slightly greater than the external diameter of upper end 4 of body member 2, such that rasp component 50 can be removeably, yet snugly fit over the upper end of the body member. Forward end 58 of rasp component 50 is closed at the top. Grate element 60 is located on an external side of rasp component 50.

In use, shroud 32 is removed from body member 2, by twisting and pulling the shroud off the body member. Rasp component 50 is then positioned on and attached, at its fitting 56, to body member 2, at which time vacuum source 15 is turned on. Dust 100 created while the user utilizes grate 60 of hollow rasp component 50 to file will be captured, collected, and accumulated within and discharged from the rasp component, through passage 12 of body member 2, through vacuum hose 16, and ultimately to vacuum source 15.

While saw and rasp attachments are specifically addressed herein, the invention should not be considered so restricted. It is contemplated that the vacuum hose attachment of the present invention can be used with sander and other dust creating tool components.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A vacuum hose attachment to be used in conjunction with a vacuum hose and vacuum source to collect dust, said attachment comprising:
a unitary tubular body member having an internal through passage, opposite ends, and connection means at one end for attachment to a vacuum hose;
an elongated cutting blade having a lower section located within the body member and an upper section extending out of the body member;
means within the body member for securing the lower section of the cutting blade to the body member; and
collection means removeably mounted on the second end of the body member for the accumulation of dust created by the use of the cutting blade, said upper section of the blade extending out of the shroud means, whereby upon application of a vacuum from a vacuum source to the vacuum hose, dust created by the cutting blade is collected within the collection means, discharged through the passage in the body member, and into the vacuum hose.

2. The vacuum hose attachment as in claim 1 wherein the body member has a given external diameter and the collection means has an external diameter greater than the external diameter of the body member.

3. The vacuum hose attachment as in claim 1 wherein the collection means comprises a shroud member.

4. The vacuum hose attachment as in claim 2 wherein the collection means comprises a rasp component.

5. The vacuum hose attachment as in claim 4 wherein the rasp component comprising a hollow member having an internal diameter greater than the external diameter of the body member, and a grate element on an external side of the rasp component.

6. The vacuum hose attachment as in claim 5 whereby upon application of a vacuum from a vacuum source to the vacuum hose, dust created by the grate element is collected within the rasp component, discharged through the passage in the body member and into the vacuum hose.

7. The vacuum hose attachment as in claim 1 wherein the tubular body member further comprises an external surface and grip means around the external surface configured to be grasp by the hand of a user.

8. The vacuum hose attachment as in claim 1 wherein both ends of the body member are open.
